(19) United States
(12) Patent Application Publication
(10) Pub. No.: US 2005/0268946 A1
(43) Pub. Date: Dec. 8, 2005

(54) Method to strip urethane coatings from automative plastic substrates

(76) Inventor: Samuel Lee Miles, Rochester Hills, MI (US)

Correspondence Address: Samuel Lee Miles, 3143 Crooks Road, Rochester Hills, MI, 48309, US

(21) Appl. No.: 11/191,495

(22) Filed: Jul. 28, 2005

Related U.S. Application Data
(63) Continuation-in-part of application No. 10/708,058, filed on Feb. 5, 2004, now abandoned.

(51) Int. Cl. B08B 7/00

(52) U.S. Cl. 134/38

(57) ABSTRACT

A method of stripping cured paint from automotive plastic substrates. A paint stripping composition consisting bromide, an evaporation inhibitor and at least one additive to accelerate stripping performance. The method utilizes a mixture that can be applied at temperatures of ambient to 200 degrees F. The invention may be utilized in an immersion tank or thickened and applied by spray, brush, roller, cloth or scraper or applied in a vapor degreaser machine. More specifically, a paint stripping method invented to salvage, recover and recycle reject or sometimes-called paint-rework automotive plastic parts, intact, without adversely affecting the parts substrate or form.

This is a continuation in part for application Ser. No. 10/708,058, filed on Feb. 5, 2004, titled: Method for Stripping Cured Paint from Low Temperature Plastic Substrates, co-pendent with an application for extension of time.

### BACKGROUND OF THE INVENTION

The Industrial, Automotive, Appliance, Agricultural and Aircraft Industries paint interior and exterior parts to protect the substrates from corrosion and to enhance the cosmetic appearance to help market the finished product. Most paint finishing manufactures and paint finishing job shops have a zero tolerance for paint defects in the final product. The first pass paint finish many times will not pass the quality inspection. Up to 30% of first pass paint finishes are rejected by the quality inspectors and sent back to be stripped and reprocessed through paint. Reject painted plastic parts are usually sold at a negative value for scrap at salvage costs or crushed into particles to recycle. The present methods for paint removal from rework painted plastic parts has been taught by the following inventors: Yamamoto, et al., in 1995, U.S. Pat. No. 5,468,779 taught a method of paint removal from plastic by first course rushing the plastic molded parts and utilizing a composition that consists; a heterocylic compound, a triazine compound and a phenylendiamine compound. In 1996, Lohr, et al., taught in U.S. Pat. No. 5,578,135 to first mechanically comminute the plastic molded parts into particles of a pour-able size then circulate in a mixture of anhydrous alkified diethylene glycol or propylene glycol at temperatures of 50 degrees C. to 75 degrees C. In August of 2003, Machac, Jr., et al., in U.S. Pat. No. 6,608,012, teaches methods to remove paint from thermoplastic polyolefin, requiring temperatures of 45 degrees C. to 75 degrees C. with a composition consisting a mixture of a carbonate, a pyrrolidone, a monoester, a ketone, a glycol ether and an organic sulfur containing compound. In December of 2003, Wiedemann, in U.S. Pat. No. 6,660,100, taught first crush the plastic parts in to small pieces prior to paint removal, then immerse the plastic pieces into an emulsion consisting an aqueous mixture of caustic lye and solvent. The inventor discovered a method to strip automotive plastic parts providing a novel process that may be placed in the paint finishing plant or job shop to strip the cured paint from the molded plastic part intact, without grinding the part for waste or partial recycle as the present art and prior has taught. The inventor teaches a method to salvage and completely recycle an automotive plastic part intact, without substrate surface damage. Prior art utilized many different compositions and methods to strip the cured paint. Prior art methods to strip cured paint include the following: High temperature bake ovens operate in the 600 F to 1200 F range, which would melt plastic parts. Abrasives are also used to strip cured paint, many times adversely affecting the substrates surface. Abrasives cannot remove cured paint from the parts hidden interior or recessed areas.

### BRIEF SUMMARY OF THE INVENTION

The inventor discovered improved methods to chemically strip urethane coatings from automotive plastic substrates at ambient temperatures with the part intact without adversely affecting the substrate surface quality. This novel mixture effectively removes the cured urethane coating from automotive plastic substrates such as: (TPO) thermal polyolefin, (TEO) thermoplastic elastomer, (ABS) acrylonitrile butadiene styrene, (PC) polycarbonate and ABS/PC blends by undercutting and lifting the coating from the substrate surface, normally in 5 to 60 minutes. More specifically, a paint stripping process invented to salvage, recover and recycle reject or sometimes called rework-painted automotive plastic production parts, Intact, without first crushing the plastic part.

### DETAILED DESCRIPTION OF THE INVENTION

The inventor discovered a novel method to strip urethane coatings from automotive plastic substrates. The method involves applying a stripping composition to a painted automotive plastic substrate, said stripping composition consisting of bromide, an evaporation inhibitor selected from the group consisting; petroleum oils, organic oils, synthetic oils, mineral oils, vegetable and plant derived oils, animal oils, fish oils, castor oils, waxes, surfactants, fatty acids, slow evaporation co-solvents, water, film forming agents and mixtures thereof, in a preferred range of 1-50 percent by weight and contains at least one additive selected from the group consisting; water, organic solvents, alcohols, aliphatic solvents, brominates, a mixture or solvent or an oxide containing a bromide element, polar solvents, non-polar solvents, naphtha, oxygenated solvents, chlorinated solvents, acetones, ketones, acetates, terpene solvents, esters, acetylene solvents, glycols, ethers, propionate solvents, carbonates, aromatic solvents, kerosene, fatty acid based solvents, vegetable based solvents, acids, inorganic acids, organic acids, fatty acids, lactic acids, glycolic acids, alkaline hydroxides, alkaline silicates, phosphates, oxides, sulfates, nitrates, alkaline salts, acid salts, amines, peroxides, oxidizers, rust inhibitors, chelators, defoamers, thickeners, fragrances, coloring agents, evaporation inhibitors, waxes, oils, surfactants and mixtures thereof.

The painted automotive plastic substrate is immersed in the stripping composition at temperatures of ambient to 200 degrees F. for approximately 5-minutes to 60-minutes, wherein the cured urethane coating is removed from the substrate. This novel method can also be applied to the painted automotive plastic substrate in a thickened form at ambient temperature for approximately 5 minutes to 60 minutes, wherein the cured urethane coating is removed from the substrate. This novel method can also be utilized by enclosing the painted automotive plastic substrate in the stripping composition in a vapor-degreasing machine, heating the stripping composition between 100 degrees F. to 200 degrees F. wherein the cured urethane coating is removed from said substrate in 5-minutes to 60-minutes.

This invention was tested for paint removal with present Automotive Urethane Paint Technologies on (TPO) thermal polyolefin automotive plastic substrates. Results were observed at 5 minutes, 30 minutes and 60 minutes at temperatures of ambient to 200 degrees F.

The time to completely strip automotive plastic parts for reprocess is provided below:

(Immersed) Parts in Bromide (without the Preferred Formic Acid Additive) at Temperatures of Ambient to 200 Degrees F.

| | % Evaporation | % Evaporation | % Evaporation |
|---|---|---|---|
| Temperature | in 5 minutes | in 30 minutes | in 60 minutes |
| Ambient 70 degrees F. | 0% | 20% | 50% |
| 100 degrees F. | 10% | 35% | 75% |
| 150 degrees F. | 25% | 50% | 100% |
| 200 degrees F. | 50% | 100% | |

(Immersed) Parts in Bromide Mixture (with the Preferred Formic Acid Additive) at Temperatures of Ambient to 200 Degrees F.

| | % Stripped | % Stripped | % Stripped |
|---|---|---|---|
| Temperature | in 5 minutes | in 30 minutes | in 60 minutes |
| Ambient 70 degrees F. | 5% | 50% | 100% |
| 100 degrees F. | 50% | 100% | |
| 150 degrees F. | 75% | 100% | |
| 200 degrees F. | 100% | | |

(Thickened) Bromide (without Preferred Formic Acid Additive), Paintbrush Application at Ambient Temperature.

| | % Stripped | % Stripped | % Stripped |
|---|---|---|---|
| Temperature | in 5 minutes | in 30 minutes | in 60 minutes |
| Ambient 70 degrees F. | 0% | 25% | 50% |

(Thickened) Bromide Mixture (with Preferred Formic Acid Additive), Paintbrush Application at Ambient Temperature.

| | % Stripped | % Stripped | % Stripped |
|---|---|---|---|
| Temperature | in 5 minutes | in 30 minutes | in 60 minutes |
| Ambient 70 degrees F. | 0% | 50% | 100% |

(Enclosed Parts in Vapor Degreasing Machine) in (Bromide without the Preferred Additive) at Temperatures of Ambient to 200 Degrees F.

| | % Stripped | % Stripped | % Stripped |
|---|---|---|---|
| Temperature | in 5 minutes | in 30 minutes | in 60 minutes |
| Ambient 70 degrees F. | 0% | 25% | 50% |
| 100 degrees F. | 30% | 50% | 100% |
| 150 degrees F. | 50% | 75% | 100% |
| 200 degrees F. | 50% | 100% | |

(Enclosed Parts in Vapor Degreasing Machine) in (Bromide Mixture with the Preferred Formic Acid Additive) at Temperatures of Ambient to 200 Degrees F.

| | % Stripped | % Stripped | % Stripped |
|---|---|---|---|
| Temperature | in 5 minutes | in 30 minutes | in 60 minutes |
| Ambient 70 degrees F. | 25% | 50% | 100% |
| 100 degrees F. | 75% | 100% | |
| 150 degrees F. | 100% | | |
| 200 degrees F. | 100% | | |

Note:
All automotive plastic painted parts had a cured urethane paint film build of 2-4 mils. Paint strip results showed that the bromide strip time was decreased (with the addition of the preferred formic acid additive) and the rise in temperature. The bromide mixture (with the preferred formic acid additive) strip time was reduced to 5 minutes in the Vapor Degreasing Machine application at 150 degrees F.

Bromide Percent Evaporation (without Evaporation Inhibitor) in Open Cup at Temperatures of Ambient to 200 Degrees F.

| | % Evaporation | % Evaporation | % Evaporation |
|---|---|---|---|
| Temperature | in 5 minutes | in 30 minutes | in 60 minutes |
| Ambient 70 degrees F. | 5% | 20% | 50% |
| 100 degrees F. | 10% | 35% | 75% |
| 150 degrees F. | 25% | 50% | 100% |
| 200 degrees F. | 50% | 100% | |

Bromide Mixture Percent Evaporation (with the Addition of the Preferred Evaporation Inhibitor) in Open Cup at Temperatures of Ambient to 200 Degrees F.

| | % Evaporation | % Evaporation | % Evaporation |
|---|---|---|---|
| Temperature | in 5 minutes | in 30 minutes | in 60 minutes |
| Ambient 70 degrees F. | 0% | 0% | 0% |
| 100 degrees F. | 0% | 2% | 5% |
| 150 degrees F. | 0% | 5% | 10% |
| 200 degrees F. | 5% | 10% | 20% |

Note:
Bromide evaporation is significantly reduced in the mixture with the addition of the preferred evaporation inhibitor.

This is a continuation in part for application Ser. No. 10/708,058, filed on Feb. 5, 2004, titled: Method for Stripping Cured Paint from Low Temperature Plastic Substrates.

### BACKGROUND OF THE INVENTION

The Industrial, Automotive, Appliance, Agricultural and Aircraft Industries paint interior and exterior parts to protect the substrates from corrosion and to enhance the cosmetic appearance to help market the finished product. Most paint finishing manufactures and paint finishing job shops have a zero tolerance for paint defects in the final product. The first pass paint finish many times will not pass the quality inspection. Up to 30% of first pass paint finishes are rejected by the quality inspectors and sent back to be stripped and reprocessed through paint. Reject painted plastic parts are usually sold at a negative value for scrap at salvage costs or crushed into particles to recycle. The present methods for paint removal from rework painted plastic parts has been taught by the following inventors: Yamamoto, et al., in 1995, U.S. Pat. No. 5,468,779 taught a method of paint removal from plastic by first course-crushing the plastic molded parts and utilizing a composition that consists; a heterocylic compound, a triazine compound and a phenylendiamine compound. In 1996, Lohr, et al., taught in U.S. Pat. No. 5,578,135 to first mechanically comminute the plastic molded parts into particles of a pour-able size then circulate in a mixture of anhydrous alkified diethylene glycol or propylene glycol at temperatures of 50 degrees C. to 75 degrees C. In August of 2003, Machac, Jr., et al., in U.S. Pat. No. 6,608,012, teaches methods to remove paint from thermoplastic polyolefin, requiring temperatures of 45 degrees C. to 75 degrees C. with a composition consisting a mixture of a carbonate, a pyrrolidone, a monoester, a ketone, a glycol ether and an organic sulfur containing compound. In December of 2003, Wiedemann, in U.S. Pat. No. 6,660,100, taught first crush the plastic parts in to small pieces prior to paint removal, then immerse the plastic pieces into an emulsion consisting an aqueous mixture of caustic lye and solvent. The inventor discovered a method to strip automotive plastic parts providing a novel process that may be placed in the paint finishing plant or job shop to strip the cured paint from the molded plastic part intact, without grinding the part for waste or partial recycle as the present art and prior has taught. The inventor teaches a method to salvage and completely recycle an automotive plastic part intact, without substrate surface damage. Prior art utilized many different compositions and methods to strip paint. Sullivan, in April 1991. U.S. Pat. No. 5,011,621 teaches of methylene-chloride free coating remover compositions that contain N-methyl-2-pyrrolidone and one or more plant or animal-derived oils. Those who are skilled in the art of paint and coating removers and strippers, are aware of the surface damage that is caused by N-methyl-2-pyrrolidone and by prior art paint and coating removal methods and compositions on Automotive plastic substrates. Doyel, in February 2004, U.S. Pat. No. 6,689,734 teaches of brominated compound mixtures combined with highly fluorinated compounds for cleaning and solvating, however did not address benefits of an evaporation retardant or evaporation inhibitor for use with the highly volatile nature of n-Propyl Bromide (NPB) or the benefits of Formic acid as a cured paint strip additive. The inventor discovered that when n-Propyl Bromide is used at the proper concentrations in a mixture of Formic Acid and an Evaporation Inhibitor and applied to a painted Automotive plastic substrate, the cured paint will undercut and separate from the plastic substrate with no damage to the plastic surface. Prior art methods to strip cured paint included the following: High temperature bake ovens operate in the 600 F to 1200 F range, which would melt plastic parts. Abrasives are also used to strip cured paint, many times adversely affecting the substrates surface. Abrasives cannot remove cured paint from the parts hidden interior or recessed areas.

### BRIEF SUMMARY OF THE INVENTION

The inventor discovered improved methods to chemically strip cured coatings from automotive plastic substrates at ambient temperatures with the part intact without adversely affecting the substrate surface quality. This novel mixture effectively removes the cured coating from automotive plastic substrates such as: (TPO) thermal polyolefin, (TEO) thermoplastic elastomer, (ABS) acrylonitrile butadiene styrene, (PC) polycarbonate and ABS/PC blends by undercutting and lifting the coating from the substrate surface, normally in 5 to 60 minutes. More specifically, a paint stripping process invented to salvage, recover and recycle reject or sometimes called rework-painted automotive plastic production parts, Intact, without first crushing the plastic part.

### DETAILED DESCRIPTION OF THE INVENTION

The inventor discovered a novel method to strip cured coatings from automotive plastic substrates. The method involves applying a stripping composition to a painted automotive plastic substrate, said stripping composition consisting of bromide, selected from the group consisting: n-propyl bromide, propyl bromide, n-butyl bromide, ethyl bromide, isopropyl bromide, cyclo hexyl bromide, n-hexyl bromide, acetyl bromide, lauryl bromide, sodium bromide, potassium bromide, n-bromo succinimide, ethyl bromo acetate, meta bromo nitro benzene, ethylene di bromide, bromo-4 benzyloxy propiophenon and inorganic bromide, hydrobromic acid, bromoethane, di bromoethane, and mixtures thereof in a range of 0.1-99.9 Percent by weight the preferred bromide is n-Propyl Bromide (CH3—CH2—CH2—Br), the preferred bromide range of 5-60 percent by weight and an evaporation inhibitor selected from the group consisting; petroleum oils, organic oils, synthetic oils, mineral oils, vegetable and plant derived oils, animal oils, fish oils, castor oils, waxes, surfactants, fatty acids, slow evaporation co-solvents, water, film forming agents and mixtures thereof, in the range of 0.1-99.5 percent by weight, the preferred evaporation inhibitor is an alcohol sulfate sodium salt, sodium ethylhexyl sulfate, (C8H17SO4Na) in a preferred range of 1-50 percent by weight, and contains at least one additive selected from the group consisting; water, organic solvents, alcohols, aliphatic solvents, brominates, a mixture or solvent or an oxide containing a bromide element, polar solvents, non-polar solvents, naphtha, oxygenated solvents, chlorinated solvents, acetones, ketones, acetates, terpene solvents, esters, acetylene solvents, glycols, ethers, propionate solvents, carbonates, aromatic solvents, kerosene, fatty acid based solvents, vegetable based solvents, acids, inorganic acids, organic acids, fatty acids, lactic acids, glycolic acids, alkaline hydroxides, alkaline silicates, phosphates, oxides, sulfates, nitrates, alkaline salts, acid salts, amines, peroxides, oxidizers, rust inhibitors, chelators, defoamers, thickeners, fragrances, coloring agents, evaporation inhibitors, waxes, oils, surfactants and mixtures thereof, in the range of 0.1-99.5 percent by weight, the preferred additive is formic acid, (HCOOH), in a preferred range of 1-50 percent by weight.

The painted automotive plastic substrate is immersed in the stripping composition at temperatures of ambient to 200 degrees F. for approximately 5-minutes to 60-minutes, wherein the cured coating is removed from the substrate. This novel method can also be applied to the painted automotive plastic substrate in a thickened form at ambient temperature for approximately 5 minutes to 60 minutes, wherein the cured coating is removed from the substrate. This novel method can also be utilized by enclosing the painted automotive plastic substrate in the stripping composition in a vapor-degreasing machine, heating the stripping composition between 100 degrees F. to 200 degrees F. wherein the cured coating is removed from said substrate in 5-minutes to 60-minutes.

This invention was tested for paint removal with present Automotive Paint Technologies on (TPO) thermal polyolefin automotive plastic substrates. Results were observed at 5 minutes, 30 minutes and 60 minutes at temperatures of ambient to 200 degrees F.

The time to completely strip automotive plastic parts, intact without adversely affecting the substrate surface quality for reprocess is provided below:

(Immersed) Parts in Bromide (without the Preferred Formic Acid Additive) at Temperatures of Ambient to 200 Degrees F.

| | % Evaporation | % Evaporation | % Evaporation |
|---|---|---|---|
| Temperature | in 5 minutes | in 30 minutes | in 60 minutes |
| Ambient 70 degrees F. | 0% | 20% | 50% |
| 100 degrees F. | 10% | 35% | 75% |
| 150 degrees F. | 25% | 50% | 100% |
| 200 degrees F. | 50% | 100% | |

(Immersed) Parts in Bromide Mixture (with the Preferred Formic Acid Additive) at Temperatures of Ambient to 200 Degrees F.

| | % Stripped | % Stripped | % Stripped |
|---|---|---|---|
| Temperature | in 5 minutes | in 30 minutes | in 60 minutes |
| Ambient 70 degrees F. | 5% | 50% | 100% |
| 100 degrees F. | 50% | 100% | |
| 150 degrees F. | 75% | 100% | |
| 200 degrees F. | 100% | | |

(Thickened) Bromide (without Preferred Formic Acid Additive), Paintbrush Application at Ambient Temperature.

| | % Stripped | % Stripped | % Stripped |
|---|---|---|---|
| Temperature | in 5 minutes | in 30 minutes | in 60 minutes |
| Ambient 70 degrees F. | 0% | 25% | 50% |

(Thickened) Bromide Mixture (with Preferred Formic Acid Additive), Paintbrush Application at Ambient Temperature.

| | % Stripped | % Stripped | % Stripped |
|---|---|---|---|
| Temperature | in 5 minutes | in 30 minutes | in 60 minutes |
| Ambient 70 degrees F. | 0% | 50% | 100% |

(Enclosed Parts in Vapor Degreasing Machine) in (Bromide without the Preferred Additive) at Temperatures of Ambient to 200 Degrees F.

| | % Stripped | % Stripped | % Stripped |
|---|---|---|---|
| Temperature | in 5 minutes | in 30 minutes | in 60 minutes |
| Ambient 70 degrees F. | 0% | 25% | 50% |
| 100 degrees F. | 30% | 50% | 100% |
| 150 degrees F. | 50% | 75% | 100% |
| 200 degrees F. | 50% | 100% | |

(Enclosed Parts in Vapor Degreasing Machine) in (Bromide Mixture with the Preferred Formic Acid Additive) at Temperatures of Ambient to 200 Degrees F.

| | % Stripped | % Stripped | % Stripped |
|---|---|---|---|
| Temperature | in 5 minutes | in 30 minutes | in 60 minutes |
| Ambient 70 degrees F. | 25% | 50% | 100% |
| 100 degrees F. | 75% | 100% | |
| 150 degrees F. | 100% | | |
| 200 degrees F. | 100% | | |

Note:
All automotive plastic painted parts had a cured paint film build of 2-4 mils. Paint strip results showed that the bromide strip time was decreased (with the addition of the preferred formic acid additive) and the rise in temperature. The bromide mixture (with the preferred formic acid additive) strip time was reduced to 5 minutes in the Vapor Degreasing Machine application at 150 degrees F.

Bromide Percent Evaporation (without Evaporation Inhibitor) in Open Cup at Temperatures of Ambient to 200 Degrees F.

| | % Evaporation | % Evaporation | % Evaporation |
|---|---|---|---|
| Temperature | in 5 minutes | in 30 minutes | in 60 minutes |
| Ambient 70 degrees F. | 5% | 20% | 50% |
| 100 degrees F. | 10% | 35% | 75% |
| 150 degrees F. | 25% | 50% | 100% |
| 200 degrees F. | 50% | 100% | |

Bromide Mixture Percent Evaporation (with the Addition of the Preferred Evaporation Inhibitor) in Open Cup at Temperatures of Ambient to 200 Degrees F.

| | % Evaporation | % Evaporation | % Evaporation |
|---|---|---|---|
| Temperature | in 5 minutes | in 30 minutes | in 60 minutes |
| Ambient 70 degrees F. | 0% | 0% | 0% |
| 100 degrees F. | 0% | 2% | 5% |
| 150 degrees F. | 0% | 5% | 10% |
| 200 degrees F. | 5% | 10% | 20% |

Note:
Bromide evaporation is significantly reduced in the mixture with the addition of the preferred evaporation inhibitor.

This invention is a novel method to strip cured coatings from automotive plastic substrates, including, not limited to the following plastic substrates: (TPO) thermal polyolefin, (TEO) thermoplastic elastomer, (ABS) acrylonitrile butadiene styrene, (PC) polycarbonate and ABS/PC blends, by undercutting and lifting the coating from the plastic substrate surface, normally in 5 to 60 minutes at temperatures of ambient to 200 F. to salvage and recycle intact, without substrate surface damage,

This is a continuation in part for application Ser. No. 10/708,058, filed on Feb. 5, 2004, titled: Method for Stripping Cured Paint from Low Temperature Plastic Substrates.

### BACKGROUND OF THE INVENTION

The Industrial, Automotive, Appliance, Agricultural and Aircraft Industries paint interior and exterior parts to protect the substrates from corrosion and to enhance the cosmetic appearance to help market the finished product. Most paint finishing manufactures and paint finishing job shops have a zero tolerance for paint defects in the final product. The first pass paint finish many times will not pass the quality inspection. Up to 30% of first pass paint finishes are rejected by the quality inspectors and sent back to be stripped and reprocessed through paint. Reject painted plastic parts are usually sold at a negative value for scrap at salvage costs or crushed into particles to recycle. The present methods for paint removal from rework painted plastic parts has been taught by the following inventors: Yamamoto, et al., in 1995, U.S. Pat. No. 5,468,779 taught a method of paint removal from plastic by first course-crushing the plastic molded parts and utilizing a composition that consists; a heterocylic compound, a triazine compound and a phenylendiamine compound. In 1996, Lohr, et al., taught in U.S. Pat. No. 5,578,135 to first mechanically comminute the plastic molded parts into particles of a pour-able size then circulate in a mixture of anhydrous alkified diethylene glycol or propylene glycol at temperatures of 50 degrees C. to 75 degrees C. In August of 2003, Machac, Jr., et al., in U.S. Pat. No. 6,608,012, teaches methods to remove paint from thermoplastic polyolefin, requiring temperatures of 45 degrees C. to 75 degrees C. with a composition consisting a mixture of a carbonate, a pyrrolidone, a monoester, a ketone, a glycol ether and an organic sulfur containing compound. In December of 2003, Wiedemann, in U.S. Pat. No. 6,660,100, taught first crush the plastic parts in to small pieces prior to paint removal, then immerse the plastic pieces into an emulsion consisting an aqueous mixture of caustic lye and solvent. The inventor discovered a method to strip automotive plastic parts providing a novel process that may be placed in the paint finishing plant or job shop to strip the cured paint from the molded plastic part intact, without grinding the part for waste or partial recycle as the present art and prior has taught. The inventor teaches a method to salvage and completely recycle an automotive plastic part intact, without substrate surface damage. Prior art utilized many different compositions and methods to strip paint. Sullivan, in April 1991, U.S. Pat. No. 5,011,621 teaches of methylene-chloride free coating remover compositions that contain N-methyl-2-pyrrolidone and one or more plant or animal-derived oils. Those who are skilled in the art of paint and coating removers and strippers, are aware of the surface damage that is caused by N-methyl-2-pyrrolidone and by prior art paint and coating removal methods and compositions on Automotive plastic substrates. Doyel, in February 2004, U.S. Pat. No. 6,689,734 teaches of brominated compound mixtures combined with highly fluorinated compounds for cleaning and solvating, however did not address benefits of an evaporation retardant or evaporation inhibitor for use with the highly volatile nature of n-Propyl Bromide (NPB) or the benefits of Formic acid as a cured paint strip additive. The inventor discovered that when n-Propyl Bromide is used at the proper concentrations in a mixture of Formic Acid and an Evaporation Inhibitor and applied to a painted Automotive plastic substrate, the cured paint will undercut and separate from the plastic substrate with no damage to the plastic surface. Prior art methods to strip cured paint include the following: High temperature bake ovens operate in the 600 F to 1200 F range, which would melt plastic parts. Abrasives are also used to strip cured paint, many times adversely affecting the substrates surface. Abrasives cannot remove cured paint from the parts hidden interior or recessed areas.

### BRIEF SUMMARY OF THE INVENTION

The inventor discovered improved methods to chemically strip cured coatings from automotive plastic substrates at ambient temperatures with the part intact without adversely affecting the substrate surface quality. This novel mixture effectively removes the cured coating from automotive plastic substrates such as: (TPO) thermal polyolefin, (TEO) thermoplastic elastomer, (ABS) acrylonitrile butadiene styrene, (PC) polycarbonate and ABS/PC blends by undercutting and lifting the coating from the substrate surface, normally in 5 to 60 minutes. More specifically, a paint stripping process invented to salvage, recover and recycle reject or sometimes called rework-painted automotive plastic production parts, Intact, without first crushing the plastic part.

### DETAILED DESCRIPTION OF THE INVENTION

The inventor discovered a novel method to strip cured coatings from automotive plastic substrates. The method involves applying a stripping composition to a painted automotive plastic substrate, said stripping composition consisting of bromide, selected from the group consisting; n-propyl bromide, propyl bromide, n-butyl bromide, ethyl bromide, isopropyl bromide, cyclo hexyl bromide, n-hexyl bromide, acetyl bromide, lauryl bromide, sodium bromide, potassium bromide, n-bromo succinimide, ethyl bromo acetate, meta bromo nitro benzene, ethylene di bromide, bromo-4 benzyloxy propiophenon and inorganic bromide, hydrobromic acid, bromoethane, di bromoethane, and mixtures thereof in a range of 0.1-99.9 percent by weight, the preferred bromide is n-Propyl Bromide (CH3—CH2—CH2—Br), the preferred bromide range of 5-60 percent by weight and an evaporation inhibitor selected from the group consisting; petroleum oils, organic oils, synthetic oils, mineral oils, vegetable and plant derived oils, animal oils, fish oils, castor oils, waxes, surfactants, fatty acids, slow evaporation co-solvents, water, film forming agents and mixtures thereof, in the range of 0.1-99.5 percent by weight, the preferred evaporation inhibitor is an alcohol sulfate sodium salt, sodium ethylhexyl sulfate, (C8H17SO4Na) in a preferred range of 1-50 percent by weight and contains at least one additive selected from the group consisting; water, organic solvents, alcohols, aliphatic solvents, brominates, a mixture or solvent or an oxide containing a bromide element, polar solvents, non-polar solvents, naphtha, oxygenated solvents, chlorinated solvents, acetones, ketones, acetates, terpene solvents, esters, acetylene solvents, glycols, ethers, propionate solvents, carbonates, aromatic solvents, kerosene, fatty acid based solvents, vegetable based solvents, acids, inorganic acids, organic acids, fatty acids, lactic acids, glycolic acids, alkaline hydroxides, alkaline silicates, phosphates, oxides, sulfates, nitrates, alkaline salts, acid salts, amines, peroxides, oxidizers, rust inhibitors, chelators, defoamers, thickeners, fragrances, coloring agents, evaporation inhibitors, waxes, oils, surfactants and mixtures thereof, in the range of 0.1-99.5 percent by weight, the preferred additive is formic acid, (HCOOH), in a preferred range of 1-50 percent by weight. The painted automotive plastic substrate is immersed in the stripping composition at temperatures of ambient to 200 degrees F. for approximately 5-minutes to 60-minutes, wherein the cured coating is removed from the substrate. This novel method can also be applied to the painted automotive plastic substrate in a thickened form at ambient temperature for approximately 5 minutes to 60 minutes, wherein the cured urethane coating is removed from the substrate. This novel method can also be utilized by enclosing the painted automotive plastic substrate in the stripping composition in a vapor-degreasing machine, heating the stripping composition between 100 degrees F. to 200 degrees F. wherein the cured coating is removed from said substrate in 5-minutes to 60-minutes.

This invention was tested for paint removal with present Automotive Paint Technologies on (TPO) thermal polyolefin automotive plastic substrates. Results were observed at 5 minutes, 30 minutes and 60 minutes at temperatures of ambient to 200 degrees F.

The time to completely strip automotive plastic parts, intact without adversely affecting the substrate surface quality for reprocess is provided below:

(Immersed) Parts in Bromide (without the Preferred Formic Acid Additive) at Temperatures of Ambient to 200 Degrees F.

| | % Evaporation | % Evaporation | % Evaporation |
|---|---|---|---|
| Temperature | in 5 minutes | in 30 minutes | in 60 minutes |
| Ambient 70 degrees F. | 0% | 20% | 50% |
| 100 degrees F. | 10% | 35% | 75% |
| 150 degrees F. | 25% | 50% | 100% |
| 200 degrees F. | 50% | 100% | |

(Immersed) Parts in Bromide Mixture (with the Preferred Formic Acid Additive) at Temperatures of Ambient to 200 Degrees F.

| | % Stripped | % Stripped | % Stripped |
|---|---|---|---|
| Temperature | in 5 minutes | in 30 minutes | in 60 minutes |
| Ambient 70 degrees F. | 5% | 50% | 100% |
| 100 degrees F. | 50% | 100% | |
| 150 degrees F. | 75% | 100% | |
| 200 degrees F. | 100% | | |

(Thickened) Bromide (without Preferred Formic Acid Additive), Paintbrush Application at Ambient Temperature.

| | % Stripped | % Stripped | % Stripped |
|---|---|---|---|
| Temperature | in 5 minutes | in 30 minutes | in 60 minutes |
| Ambient 70 degrees F. | 0% | 25% | 50% |

(Thickened) Bromide Mixture (with Preferred Formic Acid Additive), Paintbrush Application at Ambient Temperature.

| | % Stripped | % Stripped | % Stripped |
|---|---|---|---|
| Temperature | in 5 minutes | in 30 minutes | in 60 minutes |
| Ambient 70 degrees F. | 0% | 50% | 100% |

(Enclosed Parts in Vapor Degreasing Machine) in (Bromide without the Preferred Additive) at Temperatures of Ambient to 200 Degrees F.

| | % Stripped | % Stripped | % Stripped |
|---|---|---|---|
| Temperature | in 5 minutes | in 30 minutes | in 60 minutes |
| Ambient 70 degrees F. | 0% | 25% | 50% |
| 100 degrees F. | 30% | 50% | 100% |
| 150 degrees F. | 50% | 75% | 100% |
| 200 degrees F. | 50% | 100% | |

(Enclosed Parts in Vapor Degreasing Machine) in (Bromide Mixture with the Preferred Formic Acid Additive) at Temperatures of Ambient to 200 Degrees F.

| | % Stripped | % Stripped | % Stripped |
|---|---|---|---|
| Temperature | in 5 minutes | in 30 minutes | in 60 minutes |
| Ambient 70 degrees F. | 25% | 50% | 100% |
| 100 degrees F. | 75% | 100% | |
| 150 degrees F. | 100% | | |
| 200 degrees F. | 100% | | |

Note:
All automotive plastic painted parts had a cured paint film build of 2-4 mils. Paint strip results showed that the bromide strip time was decreased (with the addition of the preferred formic acid additive) and the rise in temperature. The bromide mixture (with the preferred formic acid additive) strip time was reduced to 5 minutes in the Vapor Degreasing Machine application at 150 degrees F.

Bromide Percent Evaporation (without Evaporation Inhibitor) in Open Cup at Temperatures of Ambient to 200 Degrees F.

| | % Evaporation | % Evaporation | % Evaporation |
|---|---|---|---|
| Temperature | in 5 minutes | in 30 minutes | in 60 minutes |
| Ambient 70 degrees F. | 5% | 20% | 50% |
| 100 degrees F. | 10% | 35% | 75% |
| 150 degrees F. | 25% | 50% | 100% |
| 200 degrees F. | 50% | 100% | |

Bromide Mixture Percent Evaporation (with the Addition of the Preferred Evaporation Inhibitor) in Open Cup at Temperatures of Ambient to 200 Degrees F.

| | % Evaporation | % Evaporation | % Evaporation |
|---|---|---|---|
| Temperature | in 5 minutes | in 30 minutes | in 60 minutes |
| Ambient 70 degrees F. | 0% | 0% | 0% |
| 100 degrees F. | 0% | 2% | 5% |
| 150 degrees F. | 0% | 5% | 10% |
| 200 degrees F. | 5% | 10% | 20% |

Note:
Bromide evaporation is significantly reduced in the mixture with the addition of the preferred evaporation inhibitor.

This invention is a novel method to strip cured coatings from automotive plastic substrates, including, not limited to the following plastic substrates: (TPO) thermal polyolefin, (IEO) thermoplastic elastomer, (ABS) acrylonitrile butadiene styrene, (PC) polycarbonate and ABS/PC blends, by undercutting and lifting the coating from the plastic substrate surface, normally in 5 to 60 minutes at temperatures of ambient to 200 F. to salvage and recycle intact, without substrate surface damage.

1. A method to strip cured coatings from automotive plastic substrates, including, not limited to the following plastic substrates: (TPO) thermal polyolefin, (TEO) thermoplastic elastomer, (ABS) acrylonitrile butadiene styrene, (PC) polycarbonate and ABS/PC blends, by undercutting and lifting the coating from the plastic substrate surface, normally in 5 to 60 minutes at temperatures of ambient to 200 F. to salvage and recycle intact, without substrate surface damage, said method comprising:
a) appling a stripping composition to a painted automotive plastic substrate, said stripping composition consisting of bromide, wherein said bromide is selected from the group consisting;
n-propyl bromide, propyl bromide, n-butyl bromide, ethyl bromide, isopropyl bromide, cyclo hexyl bromide, n-hexyl bromide, acetyl bromide, lauryl bromide, sodium bromide, potassium bromide, n-bromo succinimide, ethyl bromo acetate, meta bromo nitro benzene, ethylene di bromide, bromo-4 benzyloxy propiophenon and inorganic bromide, hydrobromic acid, bromoethane, di bromoethane, and mixtures thereof in a range of 0.1-99.9 percent by weight and;
b) an evaporation inhibitor selected from the group consisting;
petroleum oils, organic oils, synthetic oils, mineral oils, vegetable and plant derived oils, animal oils, fish oils, castor oils, waxes, surfactants, fatty acids, slow evaporation co-solvents, water, film forming agents and mixtures thereof in the range of 0.1-99.5 percent by weight and;
c) contains at least one additive selected from the group consisting;
water, organic solvents, alcohols, aliphatic solvents, brominates, a mixture or solvent or an oxide containing a bromide element, polar solvents, non-polar solvents, naphtha, oxygenated solvents, chlorinated solvents, acetones, ketones, acetates, terpene solvents, esters, acetylene solvents, glycols, ethers, propionate solvents, carbonates, aromatic solvents, kerosene, fatty acid based solvents, vegetable based solvents, acids, inorganic acids, organic acids, fatty acids, lactic acids, glycolic acids, alkaline hydroxides, alkaline silicates, phosphates, oxides, sulfates, nitrates, alkaline salts, acid salts, amines, peroxides, oxidizers, rust inhibitors, chelators, defoamers, thickeners, fragrances, coloring agents, evaporation inhibitors, waxes, oils, surfactants and mixtures thereof in the range of 0.1-99.5 percent by weight, wherein the cured coating is removed from said automotive plastic substrate.

2. The method of claim 1, wherein said bromide is in the range of 5-60 percent by weight.

3. The method of claim 1, wherein said evaporation inhibitor is in the range of 1-50 percent by weight.

4. The method of claim 1, wherein said additive is in the range of 1-50 percent by weight.

5. The method of claim 2, wherein said bromide is N—PROPYL BROMIDE (CH3—CH2—CH2—Br).

6. The method of claim 3, wherein said evaporation inhibitor is an alcohol sulfate sodium salt, sodium ethylhexyl sulfate, (C8H17SO4Na).

7. The method of claim 4, wherein said additive is formic acid, (HCOOH).
